(19) United States
(12) Patent Application Publication
(10) Pub. No.: US 2014/0341637 A1
(43) Pub. Date: Nov. 20, 2014

(54) DEVICE FOR FIXING THE OIL PUMP LEAF ON A HERMETIC COMPRESSOR CRANKSHAFT

(71) Applicants: Joao Paulo TURESO, Sao Carlos (BR); Gustavo SIEBERT, Sao Carlos (BR); Luis Carlos GHIDELLI, Sao Carlos (BR); Aleksandro Frederico ALVAREZ, Sao Carlos (BR)

(72) Inventors: Joao Paulo TURESO, Sao Carlos (BR); Gustavo SIEBERT, Sao Carlos (BR); Luis Carlos GHIDELLI, Sao Carlos (BR); Aleksandro Frederico ALVAREZ, Sao Carlos (BR)

(21) Appl. No.: 14/266,148

(22) Filed: Apr. 30, 2014

(30) Foreign Application Priority Data
May 2, 2013 (BR) 20 2013 010866 4

(51) Int. Cl. F04B 39/02; F16D 1/068

(52) U.S. Cl. CPC F04B 39/023; F16D 1/068
USPC 403/34

(57) ABSTRACT

A device for fixing the oil pump leaf on a hermetic compressor crankshaft used in small- and medium-sized refrigeration machines, such as refrigerators, freezer, water dispensers and others. The device (1) is coupled to a leaf (2) or without coupling and may be manufactured by polymer injection and/or composites, or even, molded or machined in metallic material.

### TECHNICAL FIELD

This refers to a request for patent of a device for fixing the oil pump leaf on the crankshaft of a hermetic compressor enclosed by a housing, used in small- and medium-sized refrigeration machines, such as refrigerators, freezers, soft drink dispensers and others.

### STATE OF THE TECHNIQUE

The oil pump has an important role for the good performance of the hermetic compressor. It has the function to lubricate the movable parts, the cooling of the stator windings and the oil aspersion inside the housing, making that the oil with higher temperature inside the compressor housing exchange heat with the housing outside (ambient).

The presence of oil, in sufficient amounts, on the compressor movable parts, is fundamental for their good functioning These components are designed to slide on the others on a hydrodynamic lubrication regimen to provide the best possible efficiency and negligible wear to the compressor. The mixed or borderline lubricating regimen conditions will only be accepted when the compressor stops and starts. This way, an efficient oil circulation through the compressor bearings is indispensible for its proper functioning

The motor winding cooling, which heats due to the Joule effect is another function of the oil. When the oil flows around the windings which are at high temperature, there is transfer of heat from the winding to the oil. The oil cools down when it makes contact with the housing that is in contact with the ambient.

With the modernization of the refrigeration systems it is necessary to use compressors with varying capacity, variable speed compressors, according to the conditions required by the refrigerator. These compressors may vary the electric motor rotation to provide higher or lower refrigeration capacity. For higher rotations the compressor oil pump fulfills its function, however, for lower rotations there is a deficiency in the oil pumping by the oil pump.

It is known from the patent literature some documents that reveal the use of technologies for distribution of lubricating oil into the internal parts of a hermetic compressor. Among them are U.S. Pat No. 3,285,504 of Nov. 15, 1966, U.S. Pat. No. 4,518,323 of May 21, 1985, GB 2,139,320 of Nov. 7, 1984, JP 63 223374 of Sep. 16, 1988, GB 2 202 905 of Oct. 5, 1988, DE 37 20 745 of Jan. 14, 1988, US2005/180871 of 18 Aug. 2005 and BRP10902430-1 of Jul. 24, 2009.

Of all mentioned documents the one that reveals a solution for the distribution of lubricant oil at low rotation is BRPI0902430-1, which describes an oil pump interconnected to the main shaft of the compressor by interference or bonding.

However, differently from all mentioned patent documents, this request of patent reveals a constructive arrangement of an oil pump provided with a device and leaf that improve the efficiency and functionality of said pump, allowing perfect lubrication for high and low rotation of the compressor motor. The device and lead can be attached into just one piece by polymer injection and/or its composites forming a unique piece, or manufactured separately and bonded by adhesive on the cover base of the device, proving to be an effective solution, of easy assembly and reduced cost for pumping oil at low rotation of the compressor motor.

### OBJECTIVE

This request of patent has the objective to reveal a fixing device of the oil pump leaf for hermetic compressor crankshaft.

The device is built in conjunction with a leaf that can be injected forming a unique piece or bonded by an adhesive to the device, forming an effective oil pumping, of easy assembly and reduced cost, lubricating the internal parts of a hermetic compressor regardless of its rotation being high or low.

### ADVANTAGES

The device presents numberless advantages, among which we highlight:
Easy assembly due to the simplicity of fit to the crankshafts by studs or adhesive;
pump oil at low rotation, since the device in view of its constructive arrangement permits perfectly and efficiently oil pumping at low rotation; and,
cost reduction, having in view that the product can be made in just one piece injected in polymer, thermoplastic or not and its composites.

### BRIEF DESCRIPTION OF THE FIGURES

FIG. 1 illustrates the device with the stud on lower view.

FIG. 2 illustrates the device with the stud on front view.

FIG. 3 illustrates the device with the stud on leaf side view.

FIG. 4 illustrates the device with the stud on right side view.

FIG. 5 illustrates the device with the stud on lower view.

FIG. 6 illustrates the device with the stud on front view.

FIG. 7 illustrates the device with the stud on front side perspective view.

FIG. 8 illustrates the device with the stud on upper side perspective view.

FIG. 9 illustrates the device without stud on lower view.

FIG. 10 illustrates the device without stud on front view.

FIG. 11 illustrates the device without stud on left side view.

FIG. 12 illustrates the device without stud on right side view.

FIG. 13 illustrates the device without stud on lower view.

FIG. 14 illustrates the device without stud on front side perspective view.

FIG. 15 illustrates the device without stud on upper side perspective view.

FIG. 16 illustrates the device on side view with the leaf inclined ready for insertion to the hermetic compressor motor.

FIG. 17 illustrates the device with stud and compressor motor shaft duly installed, both on side view.

FIG. 18 illustrates the device without stud and motor compressor shaft due installed both on side view.

FIG. 19 illustrates a hermetic compressor on side view, it can also be seen the device-shaft-compressor motor relation for the device provided with stud.

FIG. 20 illustrates a hermetic compressor on side view. It can also be seen the device-shaft-compressor motor relation for the device built without stud.

### DETAILED DESCRIPTION OF THE INVENTION

The oil pump comprises a device (1) for fixing the leaf and the leaf (2). This device (1) has the shape of a cylindrical cover (3), with the base (4) provided with three grooves (5) arranged symmetrically, resting on the side wall (6) of referred cover (3). The base center (4) receives a through hole (7) for lubricant oil passage. The side wall (6) of the cover (3) is provided with side grooves (8) for fixation of the device at the moment the crankcase is fit to the crankcase (9). Still on this wall (6), three studs (10) are located which fit to the crankshaft body (9) of the compressor. These studs (10) are formed by embosses arranged symmetrically and facing the internal part of the piece wall (3).

The leaf (2) has rectangular shape with the upper corners chamfered (11) at approximately 45°. The sides, upper and lower, have an elliptical cut (12), with the lower cut coinciding with the through hole (7) of the device (1) base (4).

The leaf (2) is attached to the device (1) base (4) forming a unique piece, joined by a convex surface (14) that interconnects the leaf (2) and the cover (3) base (4), facilitating inclination of said leaf (2) at the moment of insertion in the crankshaft (9) hole interior (13). However, this leaf (2) can also be fixed by adhesive to the device (1) base (4).

The motor crankshaft (9) of the hermetic compressor that receives the device (1) is provided with a hole (13) located on its lower face, transversal to the side of referred crankshaft (9), where the leaf (1) will be lodged when the device (1) is fit to said crankshaft (9). This crankshaft also has a groove (14) for fixing the device by means of studs (10). In cases when the crankshaft (1) has a smooth body, the device (1) may be made without the studs (10), and is bonded to the crankshaft.

The device (1) for fixing the leaf (2) when made in connection with the leaf (1) into a unique piece, may be thermoplastic polymer injected or not and/or composites, or also, molded or machined in metallic material. In both cases, they shall have chemical strength, suitable fatigue, elasticity and mechanic strength in order to withstand the compression and pull stresses imposed by the application.

The oil pump is made up of one fixing device (1) attached to leaf (2) or without attachment and to crankshaft (9).

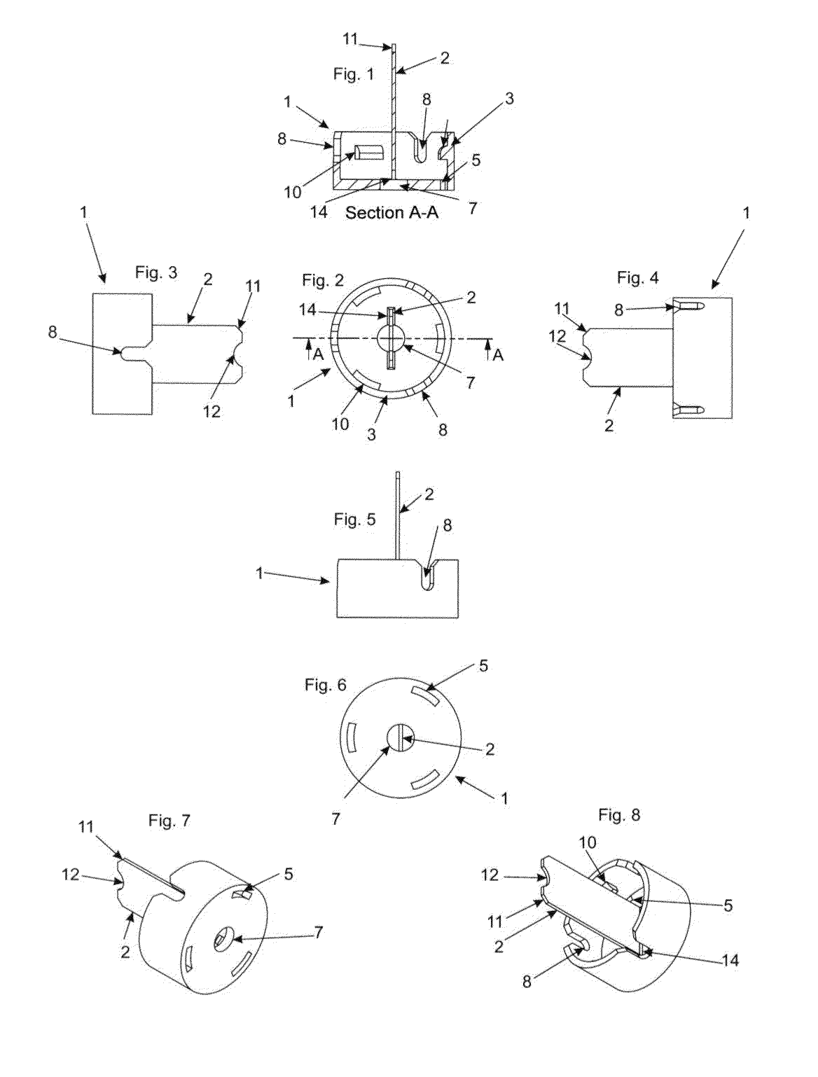

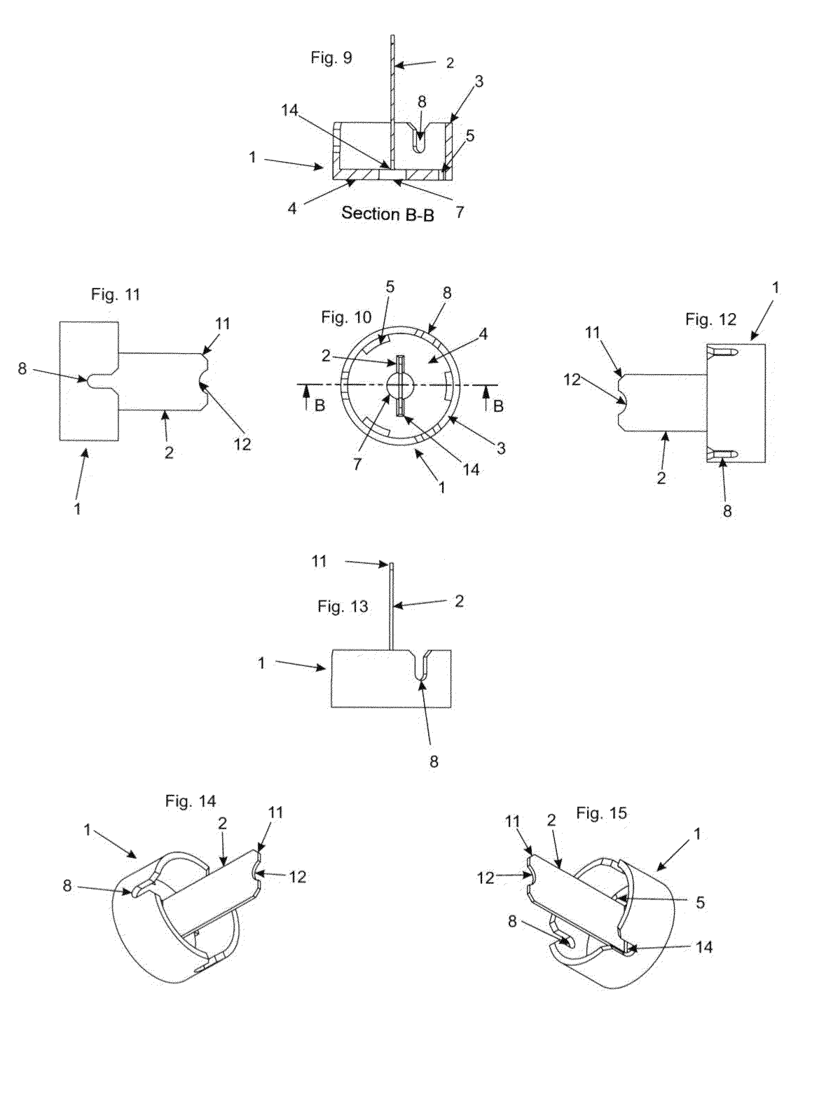

From FIGS. 1 to 8 it is possible to observe the construction of the fixing device with the leaf attached, provided with studs (10) for fixation to the crankshaft (9), whereas FIGS. 9 to 15 show the fixing device with the leaf attached without the studs for fixation to the crankshaft (9) by an adhesive.

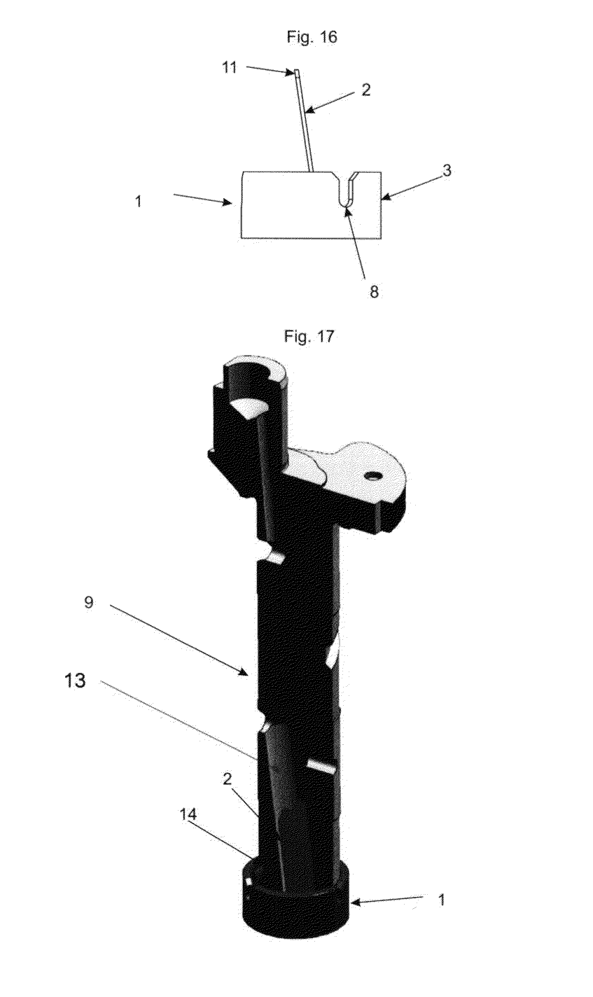

According to FIG. 16, it is possible to observe the side view of the fixing device, with the inclined leaf, ready to be inserted in the hole (13) of the compressor motor crankshaft (9).

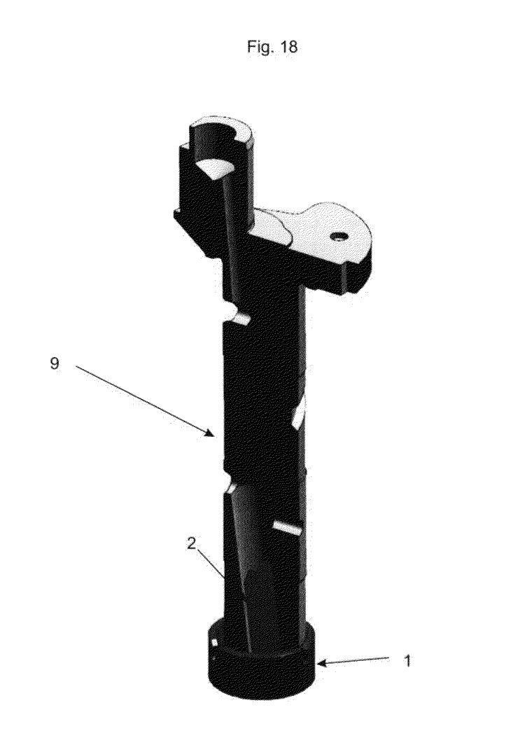

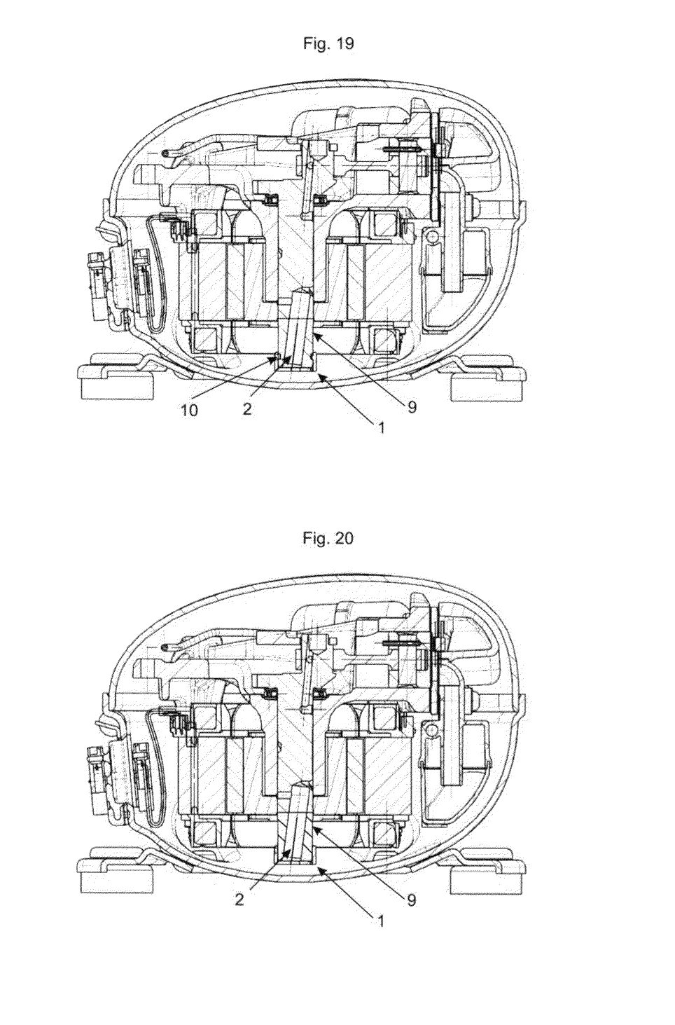

From FIGS. 17 and 18 it is possible to verify the fit of the device (1) provided with a leaf (2) on the crankshaft (9), respectively, with and without the studs, which Figures are in lateral view.

As can be seen in FIGS. 19 and 20, it is shown a hermetic compressor used in small-size refrigeration machines, such as refrigerators, freezers, water dispensers, etc. in lateral view. The motor (15) of this compressor generates a rotating movement to the crankshaft (9) which contains the oil pump provided with device (1) and leaf (2). Respectively, these Figures illustrate the device with and without the studs.

### Constructive Variants

The device (1) can be made with or without studs (10). When it is made with studs (10), it is fixed on the crankshaft (9) groove (14). However, when it is made without the studs (10), it is fixed by adhesive to the crankshaft body and this is built without the groove.

Referred device can be made from thermoplastic polymeric material or not and/or its composites aiming to facilitating the manufacturing, assembly, as well as make it possible to make the oil pump into just one piece

1. DEVICE FOR FIXING THE OIL PUMP LEAF ON THE HERMETIC COMPRESSOR CRANKSHAFT, characterized by the oil pump being made up of fixing device (1) attached to the leaf (2) or without attachment and crankshaft (9), whose device and leaf are made by polymer injection and/or composites, or also, molded or metallic material machined; the device has the shape of a cylindrical cover (3), having the base (4) provide with three grooves (5) arranged symmetrically, resting on the side wall (6) of referred cover (3) with the base center (4) provided with a through hole (7) for lubricant oil passage; the side wall (6) of the cover (3) is provide with side grooves (8) for fixation by interference of the device at the moment the crankcase fits to the crankshaft (9), as well as three studs (10) that fit to the crankshaft crankcase (9) of the compressor, these studs (10) formed by embosses arranged symmetrically and turned to the part inside; the leaf (2) with rectangular shape with upper corners chamfered (11) at approximately 45°, and the upper and lower sides with an elliptical cut (12), this lower cut coinciding with the through hole (7) of the device (1) base (4); this leaf (2) is attached to the base (4) of the device (1) forming a unique piece, joined from the convex surface (14) that interconnects the leaf (2) and the cover (3) base (4), facilitating inclination of said leaf (2) at the moment of insertion in the crankshaft (9) hole (13), however, this leaf can be fixed by adhesive to the device (1) base 4);
motor crankshaft (9) receives the device (1) leaf (2) from a hole (13) located on its lower face, transversal to the side of referred crankshaft (9), where the leaf (1) lodging the leaf when the device (1) is fit to said shaft (9), whose shaft has a groove (14) for the device through the studs (10), which can also be a smooth body for fixing the device by adhesive to the shaft (9).

2. DEVICE FOR FIXING THE OIL PUMP LEAF ON THE HERMETIC, according to claim 1, characterized by the oil pump consisting of a fixing device (1) coupled with the leaf (2) or without coupling and the crankshaft (9); the device (1) may be built wit or without studs (10), but when referred device is built with the studs (10) it is fixed on the crankshaft (9) groove (14), and when it is built without studs (10), it is fixed by adhesive to the crankshaft body and this is built without the groove.
